(19) United States
(12) Patent Application Publication
(10) Pub. No.: US 2012/0133869 A1
(43) Pub. Date: May 31, 2012

(54) LIQUID CRYSTAL DISPLAY

(75) Inventors: Chien-Ta Liao, Bade City (TW); Chun-Yi Huang, Dayuan Township (TW)

(73) Assignee: CHUNGHWA PICTURE TUBES, LTD., Bade City (TW)

(21) Appl. No.: 13/039,316

(22) Filed: Mar. 3, 2011

(30) Foreign Application Priority Data
Nov. 30, 2010 (TW) 099141531

(51) Int. Cl. G02F 1/1335

(52) U.S. Cl. 349/106

(57) ABSTRACT

Disclosed herein is a liquid crystal display device including: a first glass substrate, a second glass substrate, a liquid crystal layer, a color filter, a transparent electrode, pluralities of pixel electrodes, at least one conductive pattern, and a bias line. The liquid crystal display device has an active area and a non-active area. The liquid crystal layer is disposed between the first and second glass substrates. The color filter includes a black matrix and a pixel array, and is disposed on a surface of the first glass substrate and facing the second glass filter. The transparent electrode is disposed between the color filter and the liquid crystal layer. The pluralities of pixel electrodes are disposed on a surface of the second glass substrate and facing the transparent electrode. The least one conductive pattern is disposed on a surface of the second glass substrate in the non-active area and facing the transparent electrode, and thus an electric field is formed between the conductive pattern and the transparent electrode. The electric field is operable to absorb charged ions to mitigate the image sticking within the active area.

### CROSS-REFERENCE TO RELATED APPLICATION

This present application claims priority to TAIWAN Patent Application Serial Number 099141531, filed on Nov. 30, 2010, which is herein incorporated by reference.

### BACKGROUND

1. Technical Field

The present invention relates to a liquid crystal display. More particularly, the present invention relates to a liquid crystal display capable of mitigating the image sticking present in the display.

2. Description of Related Art

Liquid crystal displays (LCDs) are known to have advantages such as light in weight and low in power consumption, and have been widely use in various electronic application such as: notebooks, mobile phones, digital cameras, projectors, portable devices, and personal multimedia players.

Generally, a liquid crystal display is defined by two opposing glass substrates. The glass substrate has pluralities of data lines and scan lines disposed on one surface thereof and pluralities of pixels formed at the intersections of the data lines and the scan lines. Liquid crystal materials are injected into the space contained between the two glass substrates to form a liquid crystal layer. There are many kinds of ions present in the liquid crystal layer, including free ions, ion pairs, and charged particles. When an external voltage is applied across the liquid crystal layer, positive ions and negative ions would respectively move toward the opposing surfaces of the two substrates thereby forming an electric double layer (EDL) that may create an internal electric field. The internal electric field may affect the external electric field thereby resulting in problems such as image sticking.

Reference is now made to FIG. 1 which is a schematic diagram illustrating a conventional liquid crystal display 100. As shown in FIG. 1, the liquid crystal layer L is formed between the two glass substrates G1 and G2. Within the liquid crystal layer L, there are Liquid crystal molecules, free ions, ion pairs, and impurities such as charged particles. Also referred to FIG. 2 which schematically illustrates the orientations of liquid crystal molecules under the effect of the electric field during the operation of a conventional liquid crystal display. In FIG. 2, the upper parts of the drawings represent the strength of the electric fields, whereas the lower parts of the drawings represent the orientation of the liquid crystal molecules.

As shown in FIG. 2, in stage 1, an external voltage is applied across the two glass substrates G1, G2 to form an external electric field (Vapp) such that the liquid crystal molecules are rotated under the action of the external electric field.

In stage 2, the positive and negative ions respectively move toward two opposing side under the action of the external electric field thereby resulting in an internal electric field (Veff). As the internal electric field (Veff) increases gradually, it may affect the external electric field (Vapp). Meanwhile, the charged particles, due to their electric properties, would move in accordance to the direction of the electric field and gradually accumulate at the interfaces between the liquid crystal layer and the two opposing alignment films AL1, AL 2. As such, oppositely charged ions or particles would respectively gather on opposite side of the device thereby forming an electric double layer, as shown in stage 2. This is often referred to as ion effect.

Next in stage 3, with the device still being switched on, the ion effect would increases with time. As such, the effect the external electric field exerted on the liquid crystal molecules (LC) would decrease, and thereby, the liquid crystal molecules (LC) would return to its original orientation (that is, the orientation in the absence of the external electric field).

In stage 4, the device is switched off, and hence, the external voltage is no longer applied. In this case, the charged particles that were previously subjected to the action of the external electric field would move away from the respective alignment film (AL₁, AL₂) towards the reverse direction, thereby resulting in an internal electric field (Veff). At this time, the liquid crystal molecules (LC) are still subjected to the action of the internal electric field. Since the charged particles generally move in a relatively slow speed, when the external electric field no longer exists, the charged particles are not capable of returning to their original distribution. As such, the positively- and negatively-charged particles previously accumulated at two opposite sides would affect the liquid crystal molecules such that the liquid crystal molecules, in the absence of the external electric field, are not able to return to their original orientation.

In stage 5, as time passes by, the positively- and negatively-charged particles would neutralize in accordance with their respective concentration gradients, thereby gradually decreasing the internal electric field. Finally, there would be no electric field present in the device, as shown in stage 6.

Ideally, the liquid crystal molecules (LC) would only rotate under the action of the external electric field. Yet, in practice, the charged particles would generate an internal (or effective) electric field due to the ion effect. The internal electric field would not immediately disappear when the external electric field no longer exists. As such, the liquid crystal molecules (LC) would not rotate to a predetermined position, thereby resulting in image sticking that would greatly degrade the display quality of the liquid crystal display.

In view of the foregoing, image sticking is generally resulted from the accumulation of charged ions/particles within the liquid crystal layer. The sources of the charged ions/particles within the liquid crystal layer comprise the ions inherent to the liquid crystal molecules and other sources. For example, a sealant may contain pluralities of charged ions, and during the manufacturing process, the charged ions within the sealant would leak into the liquid crystal layer before the sealant is completely cured.

In order to mitigate the image sticking effect, Taiwan patent TW I315861 discloses a method for improving image sticking effect. The driving method includes applying a high voltage on the data lines for trapping impurities crossing the data lines and lowering the degree of obvious image sticking. The method is capable of reducing image sticking to some extent; yet, the charged impurities or ions are still trapped in the active area of the display, and thus, image sticking would still be present in the display. Moreover, the additional high voltage applied to the data lines may affect the electric properties of the active area, and this may downgrade the display quality.

In view of the foregoing, there exists a need in the art for providing an easy-to-manufacture liquid crystal display to effectively reduce image sticking.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one aspect, the present invention is directed to provide a liquid crystal display capable of reducing or substantially avoiding image sticking by reducing the accumulation of ions within the liquid crystal layer.

According to one embodiment of the present invention, the liquid crystal display comprises: a first glass substrate, a second glass substrate, a liquid crystal layer, a color filter, a transparent electrode, pluralities of pixel electrodes, at least one conductive pattern, and a bias line. The first and second glass substrates are opposite to each other, and the liquid crystal layer is disposed therebetween. The color filter is disposed on one surface of the first glass substrate and faces the second glass substrate, wherein the color filter comprises a black matrix and pixel array. The transparent electrode is disposed between the color filter and the liquid crystal layer. The pluralities of pixel electrodes are disposed on a surface of the second glass substrate and face the transparent electrode. The at least one conductive pattern is disposed on said surface of the second glass substrate in the non-active area and faces the transparent electrode. The bias line is electrically connected to the at least one conductive pattern, for providing the one conductive pattern a direct current potential that is different from the potential applied to the transparent electrode. In some embodiments of the present invention, the conductive pattern is disposed within the non-active area of the liquid crystal display; however, the present invention is not limited thereto. In some preferred embodiments of the present invention, the distance between the conductive pattern and the active area of the liquid crystal display is greater than the cell gap of the liquid crystal layer (that is, the distance between the conductive pattern and the transparent electrode).

In another aspect, the present invention is directed to provide a liquid crystal display capable of reducing or substantially avoiding image sticking without jeopardizing the display quality and characteristics of the liquid crystal display.

According to one embodiment of the present invention, the liquid crystal display comprises a first glass substrate, a color filter, a transparent electrode, a second glass substrate, and a liquid crystal layer. The color filter is disposed on one surface of the first glass substrate, wherein the color filter comprises: a pixel array comprising pluralities of discontinuous sub-pixels, and a black matrix disposed between the pluralities of sub-pixels. The transparent electrode overlays the pluralities of sub-pixels and the black matrix, and has openings for exposing the black matrix disposed between the pluralities of sub-pixels. The second glass substrate comprises pluralities of pixel electrodes disposed on one surface thereof, and the pluralities of pixel electrodes are opposite to the transparent electrode. The liquid crystal layer is disposed between the first glass substrate and the second glass substrate. In some preferred embodiments of the present invention, a bias line is electrically connected to the black matrix, and operable to provide the black matrix a potential that is different from the potential applied to the transparent electrode, thereby resulting in a lateral electric field for absorbing charged ions.

In another aspect, the present invention is directed to provide a color filter suitable for use in a liquid crystal display for reducing or substantially avoiding image sticking of the liquid crystal display.

According to one embodiment of the present invention, the color filter comprises: a pixel array, a black matrix, and a transparent electrode. The pixel array comprises pluralities of discontinuous sub-pixels, and the black matrix is disposed between the pluralities of sub-pixels. The transparent electrode overlies the pluralities of sub-pixels and the black matrix, and has pluralities of openings, wherein in operation, the potential applied to the black matrix is different from the potential applied to the transparent electrode, thereby resulting in a lateral electric field for absorbing charged ions. In some preferred embodiments of the present invention, the openings are formed along the source line of the liquid crystal display.

According to the principles and spirits of the present invention, a conductive structure (such as an additional conductive pattern or the black matrix) that can be driven independently could be disposed in a liquid crystal display, and a DC potential that is different from the Vcom potential could be applied to the conductive structure to generate a weak electric field. In this way, charged ions could be attracted to non-active area(s) of the liquid crystal display, which in conjunction with the light-shielding effects of the black matrix may effectively reducing or substantially avoiding the image sticking without jeopardizing the display quality. As such, the present invention would not substantially increase the manufacturing cost while would improve the yield of the final product.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is a schematic diagram illustrating the cross-sections of a conventional liquid crystal display;

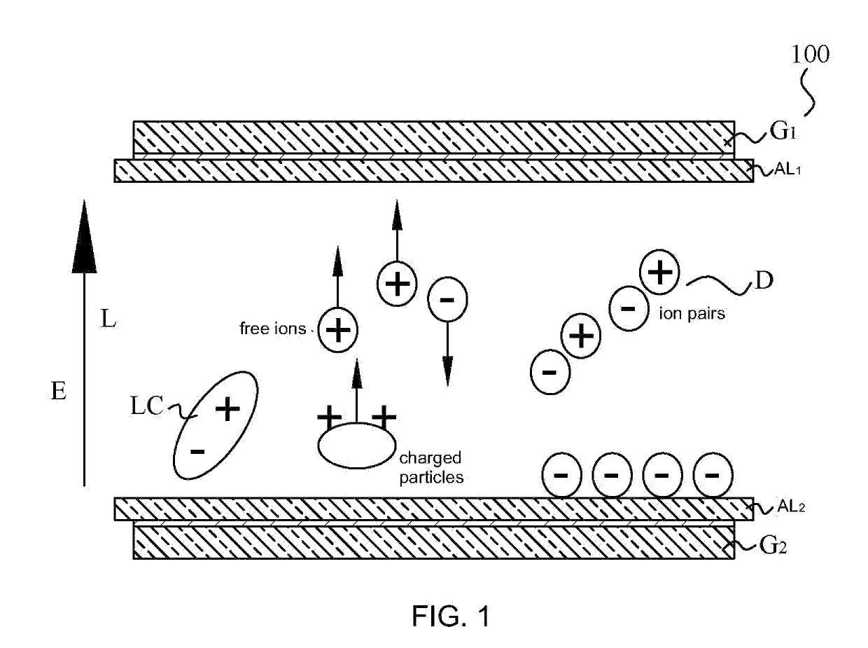

FIG. 2 is a schematic diagram illustrating the orientations of liquid crystal molecules during the operation of a conventional liquid crystal display;

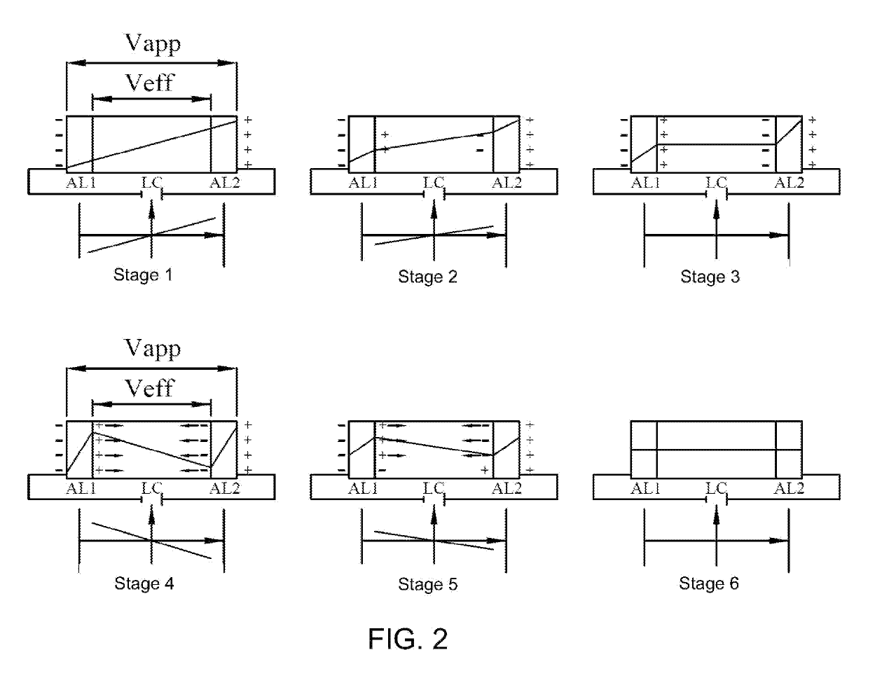

FIG. 3 is a schematic top-view diagram illustrating the structure of a liquid crystal display according to one embodiment of the present invention;

FIG. 4 is a schematic cross-sectional diagram taken along line 4-4′ in FIG. 3;

FIG. 5 is a schematic front-view diagram illustrating the structure of a liquid crystal display according to another embodiment of the present invention; and

FIG. 6 is a schematic cross-sectional diagram illustrating a liquid crystal display according to still another embodiment of the present invention.

### DETAILED DESCRIPTION

The detailed description provided below in connection with the appended drawings is intended as a description of the preferred embodiments and is not intended to represent the only forms in which the present embodiments may be constructed or utilized. The description sets forth the functions of the example and the sequence of steps for constructing and operating the embodiments. However, the same or equivalent functions and sequences may be accomplished by different examples.

In accordance with common practice, the various described features/elements are not drawn to scale but instead are drawn to best illustrate specific features/elements relevant to the present invention. Also, like reference numerals and designations in the various drawings are used to indicate like elements/parts.

The present invention discloses a liquid crystal display with reduced image sticking without jeopardizing the display quality thereof. In one aspect of the present invention, this is achieved by arranging a conductive structure that can be driven independently in the non-active area of the liquid crystal display, and then, applying a DC potential that is different from the Vcom potential to the conductive structure to generate a weak electric field. In this way, charged ions could be attracted to non-active area(s) of the liquid crystal display, which in conjunction with the light-shielding effects of the black matrix may effectively reducing or substantially avoiding the image sticking without jeopardizing the display quality. Conventionally, during the manufacturing of a liquid crystal display, a black matrix would be disposed in the non-active area or the pre-defined space between the sub-pixels (such as R, G, B) to prevent the leakage of light. According to the principles and spirits of the present invention, a conductive pattern could be disposed in the black matrix area, and the image sticking is reduced or substantially avoided by supplying a DC potential different from the Vcom potential to the conductive pattern. As such, the process for manufacturing such liquid crystal displays is highly compatible with conventional manufacturing processes without overdue modifications. Accordingly, there no substantial additional cost incurred in manufacturing such liquid crystal displays. Also, the defective percentage of the product would be substantially reduced due to the improved features.

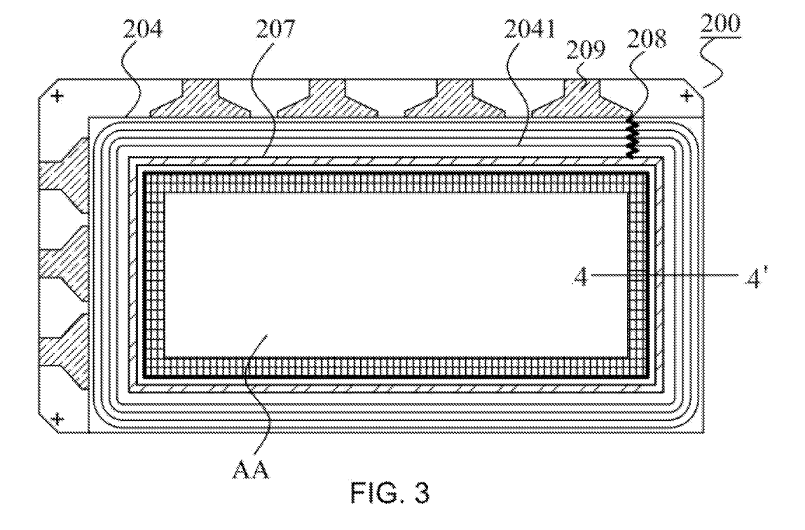

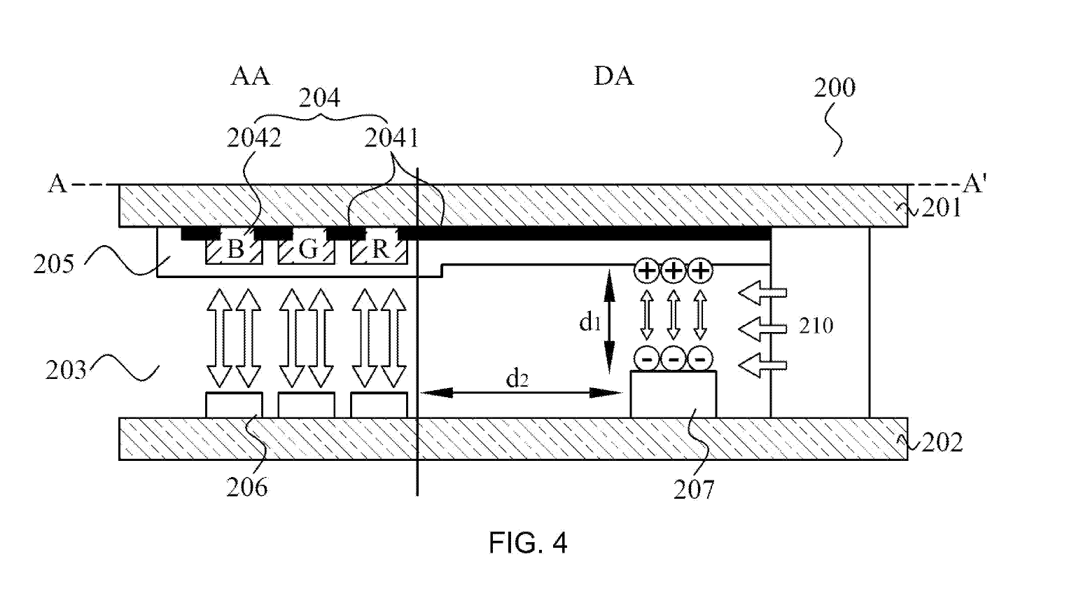

Reference is now directed to FIG. 3 and FIG. 4. FIG. 3 is a schematic top-view diagram illustrating the structure of a liquid crystal display 200 according to one embodiment of the present invention; whereas FIG. 4 is a schematic cross-sectional diagram taken along line 4-4′ in FIG. 3.

Generally, the liquid crystal display 200 may have an active area (AA) which is operable to allow the transmission of light and display an image, and a non-active area (or dark area, DA) where no light is allowed to pass through, as shown in FIG. 3.

According to the embodiment of the present invention as shown in FIG. 3 and FIG. 4, the liquid crystal display 200 comprises, from top to bottom as illustrated in FIG. 4: a first glass substrate 201, a color filter 204, a transparent electrode 205, a liquid crystal layer 203, pluralities of pixel electrodes 206, a conductive pattern 207, and second glass substrate 202. The color filter 204 is disposed on one surface of the first glass substrate 201, wherein said surface faces the second glass substrate. The transparent electrode 205 is disposed at a surface of the color filter 204 so that the color filter is sandwiched between the transparent electrode 205 and the first glass substrate 201. The liquid crystal layer 203 is disposed in adjacent to a surface of the transparent electrode 205 so that the transparent electrode 205 is sandwiched between the color filter 204 and the liquid crystal layer 203. The pluralities of pixel electrodes 206 are disposed on a surface of the second glass substrate 202 and face the transparent electrode 205. There are gaps between any two adjacent pixel electrodes 206, and the conductive pattern 207 is disposed on said surface of the second glass substrate 202 in the non-active area (DA) and faces the transparent electrode 205. As shown in FIG. 3, the conductive pattern 207 surrounds the active area (AA) and forms an enclosed pattern; however, the present invention is not limited thereto. In some other embodiments of the present invention, the conductive pattern 207 could be segmented, and in this case, a bias line 208 should be arranged at each conductive pattern segment. In one embodiment of the present invention, the liquid crystal display 200 further comprises a sealant 210 interposed between the first glass substrate 201 and the second glass substrate 202 to bond the first glass substrate 201 and the second glass substrate 202.

In the context of the present specification, the color filter 204 comprises a pixel array 2042 and black matrix 2041, as shown in FIG. 4.

Generally, the pixel array 2042 may comprise pluralities of sub-pixels formed on the first glass substrate 201. For example, the sub-pixels could be a red sub-pixel (R), a green sub-pixel (G), and a blue sub-pixel (B).

The black matrix 2041 is provided to improve the contrast of the liquid crystal display 200, prevent the leakage of light, and to shield the oblique irradiation during the operation. As shown in FIG. 4, the black matrix 2041 is disposed between the sub-pixels (R, G, B) of the pixel array 2042. Also, the black matrix 2041 surrounds the peripheral of the outermost sub-pixels, and extends into the non-active area (DA). In one embodiment of the present invention, the black matrix 2041 would overlap with a portion of each sub-pixel. Illustrative examples of materials suitable for forming the black matrix 2041 include, but are not limited to: chromium, nickel, and black resin. Of course, other materials suitable for forming the black matrix 2041 are within the scope of the present invention.

The conductive pattern 207 is disposed on the second glass substrate 202 at a position corresponding to the black matrix 2041 within the non-active area (DA), and forms an enclosed pattern. In preferred embodiments of the present invention, the liquid crystal display 200 further comprises a bias line 208 electrically coupled to the conductive pattern 207. The bias line 208 is operable to provide a DC potential that is different from Vcom potential applied to the transparent electrode 205. Optionally, the bias line 208 is electrically connected to a driving integrated circuit 209 of the liquid crystal display 200 to provide said DC potential.

The transparent electrode 205 for transmitting common signals of the liquid crystal display 200 is disposed at a surface of the color filter 204 and between the color filter 204 and the liquid crystal layer 203. Generally, the Vcom potential is applied through the transparent electrode 205 so as to provide the liquid crystal display 200 a stable reference voltage.

When the Vcom potential is applied to the transparent electrode 205, an electric field would be formed between the first glass substrate 201 and the second glass substrate 202, so that the free ions within the liquid crystal layer 203 would move toward the first glass substrate 201 and the second glass substrate 202, respectively, and accumulate at the interfaces between the liquid crystal layer 203 and the glass substrates 201, 202. In the conventional liquid crystal display, this accumulation of charged ions would result in image sticking. According to the present embodiment, the liquid crystal display 200 comprises a conductive pattern 207 disposed on the second glass substrate 202 within the non-active area (DA), and the conductive pattern 207 is electrically coupled to an external DC power source that is operable to provide a DC potential different from the Vcom potential. As such, an electric field would be formed between the conductive pattern 207 and the transparent electrode 205 due to the potential difference between the external DC potential and the Vcom potential of the transparent electrode 205. This electric field is capable of attracting the charged ions accumulating at the interfaces between the liquid crystal layer 203 and the glass substrates 201, 202, thereby reducing the effect imposed by the charged ions to the active area, and thus, reducing the image sticking.

In various embodiments of the present invention, the value of the DC potential applied to the conductive pattern 207 could be adjusted. In preferred embodiments of the present invention, the Vcom voltage could be about 0.1 to 0.3 V, whereas the potential difference between the conductive pattern 207 and the opposing transparent electrode 20 is about 0.1 to 1 V.

As shown in FIG. 4, the liquid crystal display 200 according to the present invention comprising a conductive pattern 207 disposed correspondingly to the black matrix within the non-active area. Thus, in the present invention, the conductive pattern 207 is disposed within the non-active area (DA), and in preferred embodiments of the present invention, the distance (d2, as in FIG. 4) between the conductive pattern 207 and the boundary of the active area (AA) is greater than the cell gap (d1, as in FIG. 4) of the liquid crystal layer 203 (that is, the distance between the conductive pattern 207 and the transparent electrode 205). The bias line 208 is electrically coupled to the conductive pattern 207, and is operable to provide a DC potential different from the Vcom potential applied to the transparent electrode 205. For example, the present bias line 208 is electrically connected to a driving integrated circuit of the liquid crystal display 200 to provide said DC potential.

It should be noted that the electric field generated between the conductive pattern 207 and the transparent electrode 205 may also affect the pixel electrode within the active area (AA). As such, according to the principles and spirits of the present invention, the conductive pattern 207 is preferably disposed within the non-active area (DA). Generally, the cell gap d₁ of the liquid crystal layer 203 between the transparent electrode 205 and the conductive pattern 207 is about 3 to 4 μm, whereas the distance d₂ between the pixel electrodes 206 and conductive pattern 207 is about 3 to 6 mm. In this case, the distance d₂ between the location of the conductive pattern 207 and the active area (AA) is significantly longer than the effective range of the electric field. As such, the lateral electric field generated between the conductive pattern 207 and the pixel electrodes 206 is quite weak and could be neglected. Accordingly, the lateral electric field, if present, would not affect the orientation of the liquid crystal molecules within the active area (AA).

Furthermore, as noted hereinabove, the charged particles within the sealant 210 may diffusive into the liquid crystal layer 203 before the sealant 210 is completely cured, and this charged particles may also result in the image sticking. Hence, it is possible to address the image sticking effect resulted from the charged particles originated from the sealant 210 by disposing the conductive pattern 207 in the proximity of the sealant 210.

According to various embodiments of the present invention, the materials suitable for forming the conductive pattern 207 include, but are not limited to: metal, metal alloy, conductive polymer, and other conductive materials.

Examples of materials suitable for uses on the transparent electrode 205 include, but are not limited to: indium tin oxide (ITO), indium zinc oxide (IZO), fluorine doped tin oxide (FTO), aluminum zinc oxide (AZO), gallium zinc oxide (GZO), zinc oxide (ZnO), tin dioxide (SnO₂) and the combinations of the abovementioned materials. The pixel electrodes 206 could be made of transparent conductive materials, such as those described with respect to the transparent electrode 205. As an example, rather than a limitation, the transparent electrode 205 may be made of ITO, whereas the pixel electrodes 206 may be made of IZO.

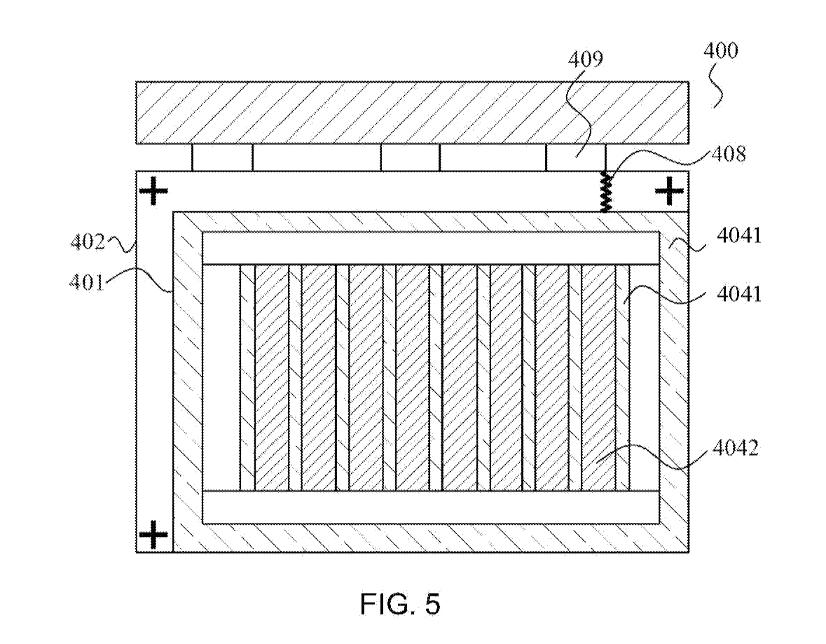

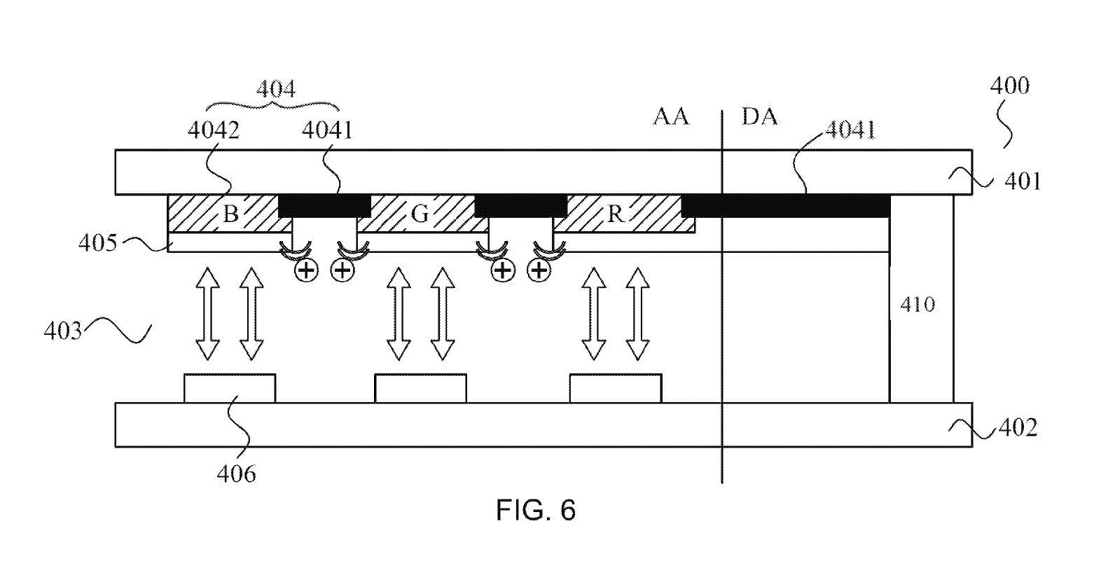

Reference is now directed to FIG. 5 and FIG. 6, which schematically illustrate the structure of a liquid crystal display 400 according to another embodiment of the present invention. The present embodiment is characterized in that the openings are formed in the transparent electrode above the source line to expose the black matrix.

As shown in FIG. 5, the liquid crystal display 400 comprises a first glass substrate 401, a color filter 404, a transparent electrode 405, a liquid crystal layer 403, and a second glass substrate 402.

The color filter 404 is disposed on a surface of the first glass substrate 401, and comprises a pixel array 4042 and a black matrix 4041. The pixel array 4042 comprises pluralities of sub-pixels, and there is gap between any adjacent sub-pixels. Generally, the black matrix 4041 is disposed between the sub-pixels; that is, disposed within the gaps between the adjacent sub-pixels. In one embodiment of the present invention, the black matrix 4041 may overlap a portion of the sub-pixels. The transparent electrode 405 is disposed on a surface of the pixel array 4042 and faces the second glass substrate 402. The second glass substrate 402 comprises pluralities of pixel electrodes 406 disposed on a surface thereon, and the pluralities of pixel electrodes 406 have a space therebetween. The positions of the pixel electrodes 406 correspond to the position of each sub-pixels of the pixel array 4042. The liquid crystal layer 403 is sandwiched between the first glass substrate 401 and the second glass substrate 402. In the present invention, the first glass substrate 401, the color filter 404, and the second glass substrate 402 are similar to those described hereinabove in connection with FIG. 4 and FIG. 5. Accordingly, detailed description regarding these structural features is omitted. In one embodiment of the present invention, the liquid crystal display 400 further comprises a sealant 410 interposed between the first glass substrate 401 and the second glass substrate 402 for bonding the first glass substrate 401 and the second glass substrate 402 together.

One of the features of the present embodiment is that the transparent electrode above the source line is patterned to have openings to expose the black matrix. Meanwhile, a DC potential different from the Vcom potential is applied to the black matrix 4041 so as to form a lateral electric field between the black matrix 4041 and the transparent electrode 405, as shown in FIG. 5 and FIG. 6. The lateral electric field is capable of attracting the free, charged particles within the pixel to the black matrix 4041 below the source line so as to reduce the image sticking. As could be appreciated by persons with ordinary skill in the art, the charged particles trapped to these black matrix area would not jeopardize the display quality due to the light-shielding nature of the black matrix 4041.

Reference is now made to FIG. 6, which is a cross-sectional diagram of the liquid crystal display 400 of FIG. 5. As shown in FIG. 6, the transparent electrode 405 is patterned to have strip openings along the source line thereby exposing the black matrix 4041. This is advantageous for creating a lateral electric field between the black matrix 4041 and the transparent electrode 405.

In the present invention, the liquid crystal display 400 further comprises a bias line 408 electrically coupled to the black matrix 4041. The bias line 408 is operable to provide a DC potential that is different from the Vcom potential applied to the transparent electrode 405. For example, the bias line 408 is electrically connected to a driving integrated circuit 409 of the liquid crystal display 400 so as to provide the DC potential. The driving integrated circuit 409 is electrically connected to a printed circuit board (not shown). In the present embodiment, a lateral electric field is formed between the black matrix 4041 and the transparent electrode 405 since the DC potential applied to the black matrix is different from the Vcom applied to the transparent electrode 405. The lateral electric field is capable of attracting the free, charged ions/particles within the pixel array 4042 thereby reducing or substantially avoiding image sticking. In various embodiments of the present invention, the DC potential applied to the black matrix 4041 could be adjusted depending on design need.

Illustrative examples of materials suitable for forming the black matrix 4041 include, but are not limited to: chromium, nickel-tungsten alloy, chromium/chromium oxide. Of course, other materials suitable for forming the black matrix 4041 are within the scope of the present invention.

Examples of materials suitable for uses on the transparent electrode 405 include, but are not limited to: indium tin oxide (ITO), indium zinc oxide (IZO), fluorine doped tin oxide (FTO), aluminum zinc oxide (AZO), gallium zinc oxide (GZO), zinc oxide (ZnO), tin dioxide (SnO₂) and the combinations of the abovementioned materials. The pixel electrodes 406 could be made of transparent conductive materials, such as those described with respect to the transparent electrode 405. As an example, rather than a limitation, the transparent electrode 405 may be made of ITO, whereas the pixel electrodes 406 may be made of IZO.

In view of the foregoing, according to the principles and spirits of the present invention, a conductive structure (such as an additional conductive pattern or the black matrix) that can be driven independently could be disposed in a liquid crystal display, and a DC potential that is different from the Vcom potential could be applied to the conductive structure to generate a weak electric field. In this way, charged ions could be attracted to non-active area(s) of the liquid crystal display, which in conjunction with the light-shielding effects of the black matrix may effectively reducing or substantially avoiding the image sticking without jeopardizing the display quality.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A liquid crystal display having an active area and a non-active area, the liquid crystal display comprising:
a first glass substrate and a second glass substrate opposite to the first glass substrate;
a liquid crystal layer disposed between the first glass substrate and the second glass substrate;
a color filter disposed on one surface of the first glass substrate and facing the second glass substrate, wherein the color filter comprises a black matrix and pixel array;
a transparent electrode disposed between the color filter and the liquid crystal layer, wherein the transparent electrode has a first potential applied thereto;
pluralities of pixel electrodes disposed on a surface of the second glass substrate and facing the transparent electrode;
at least one conductive pattern disposed on said surface of the second glass substrate in the non-active area and facing the transparent electrode, wherein the conductive pattern has a second potential applied thereto, and the second potential is different from the first potential, thereby forming an electric field between the transparent electrode and the conductive pattern; and
a bias line electrically connected to the at least one conductive pattern, for providing the second potential to the at least one conductive pattern.

2. The liquid crystal display of the claim 1, wherein the distance between the conductive pattern and the pixel electrodes is greater than the distance between the conductive pattern and the transparent electrode.

3. The liquid crystal display of the claim 1, wherein the material of the black matrix is chromium, nickel or black resin.

4. The liquid crystal display of the claim 1, wherein the material of the at least one conductive pattern is a metal or a metal alloy.

5. A liquid crystal display, comprising:
a first glass substrate;
a color filter disposed on one surface of the first glass substrate, wherein the color filter comprises: a pixel array and a black matrix, wherein the pixel array comprises pluralities of discontinuous sub-pixels, and the black matrix is disposed between the pluralities of sub-pixels;
a transparent electrode, overlaying the pluralities of sub-pixels and the black matrix, wherein the transparent electrode has openings for exposing the black matrix disposed between the pluralities of sub-pixels;
a second glass substrate, wherein the second glass substrate comprises pluralities of pixel electrodes disposed on one surface thereof, and the pluralities of pixel electrodes faces the transparent electrode; and
a liquid crystal layer, disposed between the first glass substrate and the second glass substrate.

6. The liquid crystal display of the claim 5, further comprising:
a bias line coupled to the black matrix, wherein the bias line is operable to provide a potential different from the potential applied to the transparent electrode, thereby forming a lateral electric field between the black matrix and the transparent electrode.

7. The liquid crystal display of the claim 5, wherein the material of the black matrix is any one of: chromium, nickel-tungsten alloy, chromium/chromium oxide or other conductive materials suitable for forming the black matrix.

8. A color filter, comprising:
a pixel array comprising pluralities of discontinuous sub-pixels;
a black matrix disposed between the pluralities of sub-pixels; and
a transparent electrode overlaying the pluralities of sub-pixels and the black matrix, wherein the transparent electrode has pluralities of openings for exposing the black matrix disposed between the pluralities of sub-pixels, and in operation, the potential applied to the black matrix is different from the potential applied to the transparent electrode.

9. The color filter of claim 8, wherein the pluralities of openings is formed along a source line of a liquid crystal display.
